(19) United States
(12) Patent Application Publication
(10) Pub. No.: US 2024/0106038 A1
(43) Pub. Date: Mar. 28, 2024

(54) PLASTIC COMPONENT AND BATTERY HAVING THE SAME

(71) Applicant: XIAMEN HITHIUM ENERGY STORAGE TECHNOLOGY CO., LTD., Xiamen (CN)

(72) Inventors: Jinyun LIANG, Xiamen (CN); Weidong XU, Xiamen (CN)

(21) Appl. No.: 18/516,961

(22) Filed: Nov. 22, 2023

Related U.S. Application Data
(63) Continuation of application No. PCT/CN2022/142431, filed on Dec. 27, 2022.

(30) Foreign Application Priority Data
Sep. 27, 2022 (CN) 202211184994.8

(51) Int. Cl. H01M 50/15; H01M 50/169; H01M 50/627

(52) U.S. Cl. CPC H01M 50/15; H01M 50/169; H01M 50/627

(57) ABSTRACT

Provided are a plastic component and a battery having the same. The plastic component includes a body having a first side surface and a second side surface facing away from the first side surface. The first side surface has a buffer recess recessed towards the second side surface. The buffer recess has at least one flow guide hole penetrating the body in a thickness direction of the body. The second side surface has a connection piece recess recessed towards the first side surface, and the connection piece recess has a pole through hole penetrating the body in the thickness direction of the body.

### CROSS-REFERENCE TO RELATED APPLICATIONS

The present application is a continuation of International Application No. PCT/CN2022/142431, filed on Dec. 27, 2022, which is based on and claims priority to Chinese Patent Application No. 202211184994.8, filed on Sep. 27, 2022 and entitled with “PLASTIC COMPONENT AND BATTERY HAVING THE SAME”, the entire content of which is incorporated herein by reference.

### FIELD

The present disclosure relates to the field of battery technologies, and in particular, to a plastic component and a battery having the same.

### BACKGROUND

At present, a plastic component is molded by using injection technology in a molding cavity, with a speed of molding closely related to a thickness of the plastic component. When producing a larger-sized plastic component, a thick plastic component is needed to ensure its strength. However, this results in slower injection molding efficiency or even failure of molding of the plastic component, SUMMARY

The present disclosure proposes a plastic component.

The present disclosure further proposes a battery having the same.

The plastic component according to embodiments of the present disclosure includes a body having a first side surface and a second side surface facing away from the first side surface. The first side surface has a buffer recess recessed towards the second side surface, the buffer recess has at least one flow guide hole penetrating the body in a thickness direction of the body, the second side surface has a connection piece recess recessed towards the first side surface, and the connection piece recess has a pole through hole penetrating the body in the thickness direction of the body.

A battery according to another aspect of the embodiments of the present disclosure includes the plastic component according to the above embodiments of the present disclosure.

The additional aspects and the advantages of the present disclosure will be partially set forth in the following description, and in part will be apparent from the following description, or may be learned by practice of the present disclosure.

### BRIEF DESCRIPTION OF THE DRAWINGS

FIG. 1 is a perspective view of a plastic component from a perspective according to an embodiment of the present disclosure.

FIG. 2 is a perspective view of a plastic component from another perspective according to an embodiment of the present disclosure.

FIG. 3 is a top view of a plastic component according to an embodiment of the present disclosure.

FIG. 4 is a cross-sectional view of A-A in FIG. 3.

FIG. 5 is a schematic view of a thickness of a body, a depth of a buffer recess, and a depth of a connection piece recess.

FIG. 6 is a bottom view of a plastic component according to an embodiment of the present disclosure.

FIG. 7 is a schematic view of a thinned recess of a plastic component according to an embodiment of the present disclosure.

FIG. 8 is a bottom view of a plastic component according to another embodiment of the present disclosure.

FIG. 9 is a perspective view of a connection piece.

FIG. 10 is a schematic view of an assembly of a cover plate, a plastic component, a connection piece, and a bare cell.

FIG. 11 is a schematic view of a relative position between a bare cell and a plastic component.

### REFERENCE SIGNS

plastic component 10; first side surface 1; buffer recess 11; flow guide hole 12; second side surface 2; connection piece recess 21; rounded corner 211; positioning protruding post 212; thinned recess 22; outer peripheral recess wall 221; recess bottom wall 222; outer peripheral surface 3; pole through hole 4; cover plate 20; liquid injection hole 201; connection piece 30; pole connection segment 301; tab connection segment 302; bare cell 40; tab 401; protrusion 402; proximal portion 4021; and distal portion 4022.

### DETAILED DESCRIPTION

Embodiments of the present disclosure will be described in detail below, and examples of the embodiments are shown in the accompanying drawings, in which identical or similar reference signs denote identical or similar elements or elements with identical or similar functions through the accompanying drawings. The following embodiments described with reference to the drawings are illustrative and intended to explain the present disclosure, rather than being interpreted as limitations on the present disclosure.

In description of the present disclosure, it should be understood that orientations or positional relationships indicated by terms “longitudinal”, “transverse”, “length”, “width”, “thickness”, “upper”, “lower”, “front”, “rear”, “left”, “right”, “vertical”, “horizontal”, “top”, “bottom”, “inner”, “outer”, and the like are based on orientations or positional relationships shown in the drawings, and facilitate the description of the present disclosure and simplify the description merely, rather than indicating or implying that the associated apparatus or element must have specific orientations and are constructed and operated in the specific orientations, and thus should not be construed to limit the present disclosure.

Moreover, the terms “first” and “second” are used only for description and shall not be interpreted as an indication or implication of relative importance or an implicit indication of the number of technical features. Thus, features associated with “first” and “second” may include at least one or more such features, either explicitly or implicitly. In the description of the present disclosure, “a plurality of” means two or more, unless otherwise specifically defined.

In the present disclosure, unless otherwise specifically stated and defined, terms “mounted”, “connect”, “connect to”, “fixed”, and the like should be understood broadly. For example, it may be a fixed connection or detachable connection or integrally formed; it may be a mechanical connection, an electric connection, or a communication; it may be a direct connection, an indirect connection through an intermediary, or a communication between the interiors of two elements or mutual acting relationship between the two elements. For those skilled in the art, the specific meaning of the above-mentioned terms in the embodiments of the present disclosure can be understood according to specific circumstances.

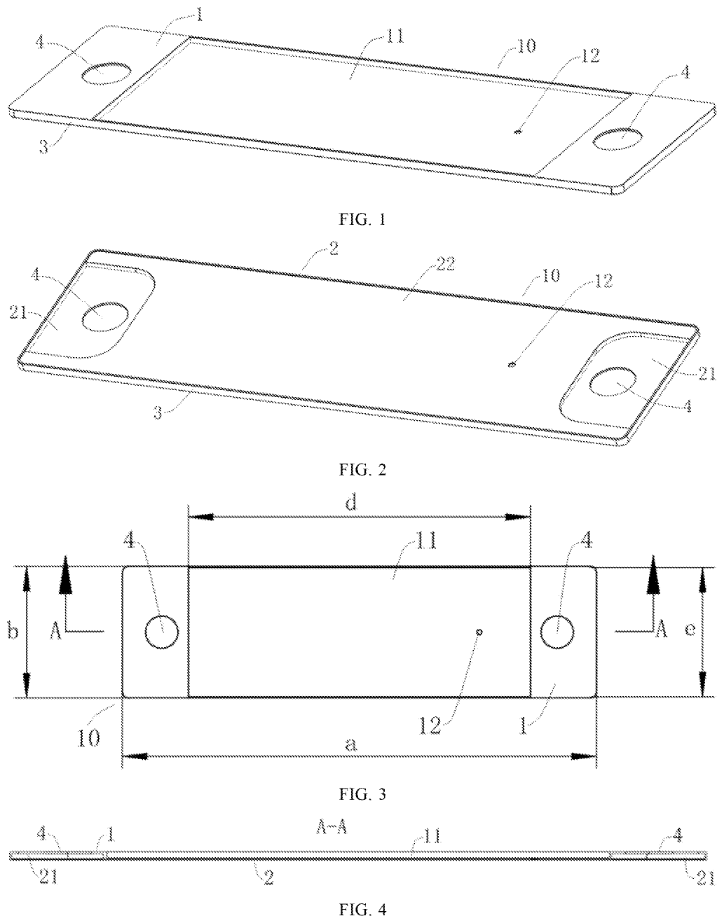

A plastic component 10 according to embodiments of the present disclosure will be described in detail with reference to FIG. 1 to FIG. 11. The plastic component 10 may be used in a battery. The battery includes a housing and a battery top cover. The housing has a receiving space, and the receiving space is provided with a battery cell. The battery top cover is used for sealing an opening of the receiving space. In some embodiments, the plastic component 10 may be formed as a part of the battery top cover.

Referring to FIG. 1 to FIG. 6, the plastic component 10 according to an embodiment of the present disclosure includes a body having a first side surface 1 and a second side surface 2 facing away from the first side surface 1. In some embodiments, in FIG. 1, an upper surface of the body is the first side surface 1, and a lower surface of the body is the second side surface 2.

The first side surface 1 has a buffer recess 11, and the buffer recess 11 is recessed towards a direction where the second side surface 2 is located. As illustrated in FIG. 1, the buffer recess 11 is recessed downwards. The buffer recess 11 has a flow guide hole 12, and the flow guide hole 12 penetrates the body in a thickness direction of the body. When the plastic component 10 is applied in the battery, an operation of injecting liquid into the battery may be completed through the flow guide hole 12. The buffer recess 11 is used as a buffer region of electrolyte, which may effectively prevent over-sized liquid injection pressure from damaging the bare cell in a battery casing. Moreover, it is possible to balance air pressure in the battery cell. At least one flow guide hole 12 is provided. A recessed structure of the buffer recess 11 also enhances a mechanical strength of a liquid injection region of the body to some extent.

In some embodiments of the present disclosure, one flow guide hole 12 is provided, thereby facilitating simplification of processing process of the plastic component 10. Moreover, a liquid injection process is easy to manage when a number of the flow guide holes 12 is small.

In some embodiments of the present disclosure, a plurality of flow guide holes 12 is provided, thereby facilitating an improvement in liquid injection efficiency.

The second side surface 2 has a connection piece recess 21, and the connection piece recess 21 is recessed towards a direction where the first side surface 1 is located. When the plastic component 10 is applied in the battery, a connection piece may be at least partially installed and positioned in the connection piece recess 21, thereby facilitating a reduction in an overall thickness of the connection piece after the connection piece is connected to the plastic component 10. In addition, a recessed structure of the connection piece recess 21 strengthens a mechanical strength of a connection piece region of the body to some extent.

Referring to FIG. 1 to FIG. 6, a pole through hole 4 is formed at the connection piece recess 21 and penetrates the body in the thickness direction of the body. The pole through hole 4 is used for a pole to pass through, and the connection piece is welded and fixed to the pole.

In some embodiments of the present disclosure, referring to FIG. 6, the pole through hole 4 is located at a center of the body in a width direction of the body, i.e., H1=H2. In this way, a structure of the plastic component 10 is an axisymmetric structure. When the plastic component 10 is installed in the battery, the plastic component 10 has no directivity. Moreover, even if the plastic component 10 is horizontally rotated by 180°, the plastic component 10 is still viable, thereby facilitating saving an assembly time.

In some embodiments of the present disclosure, referring to FIG. 6, the connection piece recess 21 has a first side wall close to the buffer recess 11 and a second side wall away from the buffer recess 11. A distance between the pole through hole 4 and the second side wall is greater than a distance between the pole through hole 4 and the first side wall. It may be noted that “the distance between the pole through hole 4 and the second side wall” refers to a distance between a center of the pole through hole 4 and the second side wall, “the distance between the center of the pole through hole 4 and the first side wall” refers to a distance between the center of the pole through hole 4 and the first side wall, and the distance between the center of the pole through hole 4 and the second side wall is greater than the distance between the center of the pole through hole 4 and the first side wall, i.e., H3>H4. In this way, the center of the pole through hole 4 is far away from an edge of the body, which may reduce a hole cracking risk at the pole through hole 4.

In the plastic component 10 according to the embodiments of the present disclosure, the buffer recess 11 is formed at the first side surface 1 of the body, so that the electrolyte may be buffered, and the bare cell in the battery casing may be prevented from being damaged due to excessive liquid injection pressure. Moreover, a material of the body may be decreased. By defining the connection piece recess 21 at the second side surface 2, it is possible to lower the overall thickness of the connection piece after being connected to the plastic component 10 and further reduce the material of the body. Therefore, the material required for forming the plastic component 10 and the time required for injection molding cooling are saved, and the cost is greatly saved.

In some embodiments of the present disclosure, projection regions of the connection piece recess 21 and the buffer recess 11 on the body are offset from each other. In this way, the thickness of the body is not excessively reduced, which helps keep the body higher in strength.

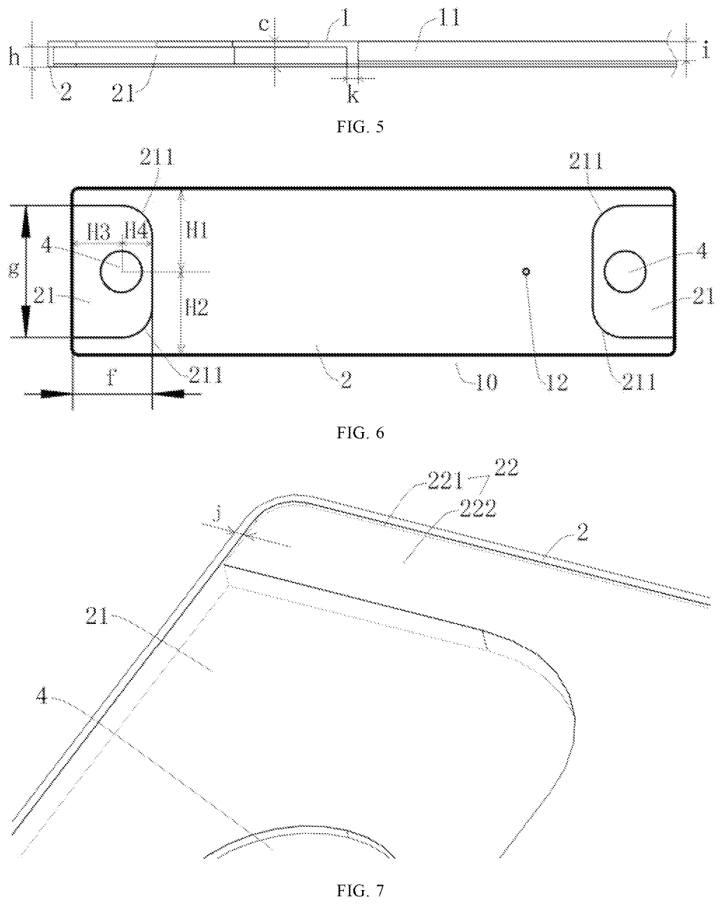

According to some embodiments of the present disclosure, an offset between the projection region of the connection piece recess 21 on the body and the projection region of the buffer recess 11 on the body is greater than 0.7 mm and smaller than 1 mm. In other words, the offset between the projection region of the connection piece recess 21 on the body and the projection region of the buffer recess 11 on the body is in a range of 0.7 mm to 1 mm. As illustrated in FIG. 5, the offset between the projection region of the connection piece recess 21 on the body and the projection region of the buffer recess 11 on the body is k, and K is greater than or equal to 0.7 mm and smaller than or equal to 1 mm. When k is smaller than 0.7 mm, a connection strength between the connection piece recess 21 and the buffer recess 11 is small, and the body is easy to crack in a region between the connection piece recess 21 and the buffer recess 11; and when k is greater than 1 mm, it will result in significant fluctuations in the thickness of the body, consequently leading to an increased level of injection molding difficulty and a decreased success rate of injection molding. Exemplarily, k may be 0.7 mm, 0.8 mm, 0.9 mm, 1 mm, or the like. Certainly, k may also be other numerical values in the range of 0.7 mm and 1 mm. The enumeration of details shall be eschewed henceforth.

In some embodiments of the present disclosure, referring to FIG. 2, FIG. 4, and FIG. 6, the second side surface 2 has two connection piece recesses 21 located at two ends of the buffer recess 11, respectively. In this way, the connection piece region is offset from a liquid injection buffer region, which is beneficial to reasonably utilizing a space. Moreover, the two connection piece recesses 21 facilitate a connection between the plastic component 10 and the two connection pieces. The recessed structure of the buffer recess 11 enhances a mechanical strength of a middle region of the body to some extent. Moreover, the recessed structure of the connection piece recess 21 strengthens a mechanical strength of regions at the two ends of the body to some extent.

In some embodiments of the present disclosure, referring to FIG. 2 and FIG. 7, the body has a predetermined thickness. The first side surface 1 is connected to the second side surface 2 through an outer peripheral surface 3, and the second side surface 2 has a thinned recess 22 having an outer peripheral recess wall 221 and a recess bottom wall 222. The outer peripheral recess wall 221 is apart from the outer peripheral surface 3, and the connection piece recess 21 is formed at the recess bottom wall 222. By defining the thinned recess 22, a mechanical strength of the second side surface 2 of the body may be enhanced to some extent. The thinned recess 22 may also be used as a hot melting region of a polyester film Mylar. In some embodiments, a top of the polyester film Mylar is disposed in the thinned recess 22, and a connection between the polyester film Mylar and the body is realized through a hot melting process.

In some embodiments of the present disclosure, a distance between the outer peripheral recess wall 221 and the outer peripheral surface 3 is smaller than or equal to 10 mm, thus ensuring a high strength of the body, while avoiding a decrease in strength caused by a thin edge of the body. Referring to FIG. 7, the distance between the outer peripheral recess wall 221 and the outer peripheral surface 3 is j, and j is smaller than or equal to 10 run. Exemplarily, j may be 2 mm, 4 mm, 5 mm, 6 mm, 10 mm, or the like. Certainly, j may also be other numerical values smaller than 10 mm, which are not listed here.

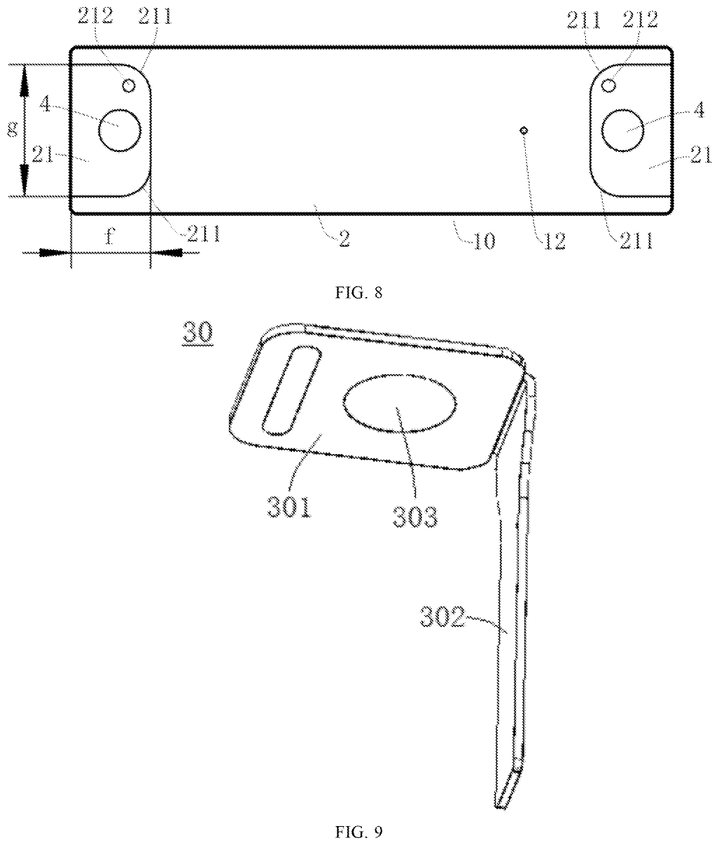

According to some embodiments of the present disclosure, referring to FIG. 8, the connection piece recess 21 is provided with a positioning protruding post 212 protruding towards away from the first side surface 1. The positioning protruding post 212 has an end surface flush with the recess bottom wall 222 of the thinned recess 22. The positioning protruding post 212 is offset from the pole through hole 4 and may position the connection piece. For example, the connection piece has a positioning hole, and the positioning protruding post 212 is inserted into the positioning hole. Therefore, positioning of the connection piece in the connection piece recess 21 is realized, thereby facilitating welding and fixing of the connection piece and the pole in the pole through hole 4.

In some embodiments of the present disclosure, the body is of a flat plate-like structure and has a length greater than or equal to 300 mm and a width greater than or equal to 107 mm. In this way, it can be guaranteed that the body is matched with the corresponding battery, preventing any negative impact on normal use of the body due to its size being too small. Moreover, the thickness of the body is greater than or equal to 4 mm, which may ensure that the strength of the body is excessively reduced because the thickness of the body is too thin. In some embodiments, referring to FIG. 3 to FIG. 5, the length of the body is a, where a is greater than or equal to 300 mm, a width of the body is b, where b is greater than or equal to 107 mm, and the thickness of the body is c, where c is greater than or equal to 4 mm. Exemplarily, a may be 300 mm, 310 mm, 320 mm, 330 mm, 340 mm, etc., b may be 107 mm, 110 mm, 113 mm, 116 mm, 119 mm, etc., c may be 4 mm, 6 mm, 8 mm, 10 mm, 12 mm, etc. Of course, a, b, and c may also be other numerical values greater than their respective lower limit values, which are not exhaustively listed herein.

In some embodiments of the present disclosure, the thickness of the body is smaller than or equal to 30 mm, which may ensure that the body is thin, thus saving materials. The thin body is beneficial to improving injection molding efficiency of the plastic component 10, as well as increasing a success rate of forming the plastic component 10.

In some embodiments of the present disclosure, a length of the buffer recess 11 is greater than or equal to 285 mm, a width of the buffer recess 11 is greater than or equal to 100 mm, and a depth of the buffer recess 11 is greater than or equal to 2.5 mm. In this way, it can be ensured that the buffer recess 11 is matched with the corresponding battery, with a great region and sufficient depth. The buffer recess 11 can well buffer the liquid during liquid injection, avoiding a case where a dimension of the buffer recess 11 is too small and affects a buffer effect on the liquid during injection, such as liquid overflow. In some embodiments, referring to FIG. 3 to FIG. 5, the length of the buffer recess 11 is d, where d is greater than or equal to 285 mm. The width of the buffer recess 11 is e, where e is greater than or equal to 100 mm. The depth of the buffer recess 11 is i, and i is greater than or equal to 2.5 mm. Exemplarily, d may be 2 mm, 4 mm, 5 mm, 6 mm, 10 mm, etc., e may be 100 mm, 104 mm, 108 mm, 112 mm, 116 mm, etc., and i may be 2.5 mm, 2.7 mm, 2.9 mm, 3.1 mm, 3.3 mm, etc. Certainly, d, e, and i may also be other numerical values greater than their respective lower limit values, which will not be exhaustively listed here.

In some embodiments of the present disclosure, a dimension of the connection piece recess 21 in a length direction of the body is greater than or equal to 50 mm, a dimension of the connection piece recess 21 in a width direction of the body is greater than or equal to 86 mm, and a depth of the connection piece recess 21 is greater than or equal to 2.5 mm. In this way, it can be ensured that the connection piece recess 21 is matched with the corresponding battery, with the great region and sufficient depth, thereby lowering a connection difficulty when the connection piece recess 21 is connected to the connection piece. In some embodiments, referring to FIG. 5 and FIG. 6, the dimension of the connection piece recess 21 in the length direction of the body is f; where f is greater than or equal to 50 mm. The dimension of the connection piece recess 21 in the width direction of the body is g, where g is greater than or equal to 86 mm. The depth of the connection piece recess 21 is h, and h is greater than or equal to 2.5 mm. Exemplarily, f may be 50 mm, 52 mm, 54 mm, 56 mm, 58 mm, and so on. Similarly, g may be 86 mm, 88 mm, 90 mm, 92 mm, 94 mm, and so forth. Likewise, h may be 2.5 mm, 2.7 mm, 2.9 mm, 3.1 mm, 3.3 mm, etc. Certainly, f, g, and h may also exceed their respective lower limit values, which will not enumerate all possible values for f; g, and h herein.

In some embodiments of the present disclosure, referring to FIG. 6, the connection piece recess 21 has a rounded corner 211 arranged at a side of the connection piece recess 21 close to the buffer recess 11 is a rounded corner 211. A fillet radius of the rounded corner 211 is greater than 5 mm and smaller than 20 mm, i.e., a fillet radius of the rounded corner 211 is in a range of 5 mm to 20 mm. A fillet size of the rounded corner 211 matches an outer dimension of the connection piece, allowing the rounded corner 211 to perform position restriction on the connection piece. In addition, compared with a right angle, a structure of the rounded corner 211 may also alleviate a stress concentration phenomenon at the corner of the connection piece recess 21, avoiding fracture of the plastic component 10. Exemplarily, the fillet radius of the rounded corner 211 may be 5 mm, 10 mm, 15 mm, 20 mm, etc. Of course, the fillet radius of the rounded corner 211 may also be any other value in the range of 5 mm and 20 mm, without listing them individually here.

In some embodiments of the present disclosure, the body may further have a liquid return hole penetrating the body in the thickness direction of the body, allowing the electrolyte at a top of the body to flow back through the liquid return hole when the battery is inverted.

According to another aspect of the embodiments of the present disclosure, a battery includes the plastic component 10 according to the above embodiments.

For the battery according to the embodiments of the present disclosure, the plastic component 10 included by the battery resolves technical barriers associated with injection molding difficulties caused by excessive thickness in a large-sized plastic component 10. Moreover, mechanical structures of the plastic component 10 like the buffer recess 11 and the connection piece recess 21 are provided at a plurality of positions of the plastic component 10, thereby allowing feasibility of the large-sized plastic component 10 to be realized. In addition, the thinned design of the buffer recess 11 and the connection piece recess 21 saves the material required for molding the plastic component 10 and cooling time required for injection molding, thus lowering most of the cost. Moreover, the buffer recess 11 is added on the plastic component 10 to serve as an electrolyte buffer region, which addresses a technical challenge of bare cell damage due to excessive hydraulic pressure during rapid infusion in a large-sized battery cell. Moreover, the connection piece recess 21 is added to the plastic component 10 to serve as a connection piece connecting region, which solves the technical problem of a great thickness of the connection piece after the connection piece is connected to the plastic component 10.

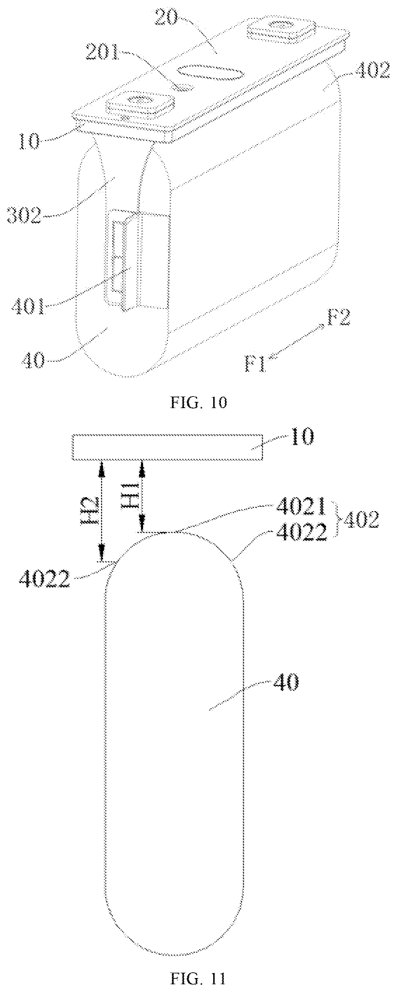

In some embodiments of the present disclosure, as illustrated in FIG. 1, FIG. 2, and FIG. 10, the battery further includes a cover plate 20. The cover plate 20 is located at a side of a first side surface 1 of the plastic component and has a liquid injection hole 201. A projection of the liquid injection hole 201 on the first side surface 1 is located at a buffer recess 11, and a flow guide hole 12 is offset from the liquid injection hole 201. In this way, after the electrolyte enters the buffer recess 11 from the liquid injection hole 201, the electrolyte may be fully buffered in the buffer recess 11, and then enter the battery from the flow guide hole 12, thereby reducing an impact force of the electrolyte on an interior of the battery and allowing the liquid injection process to be more stable. As illustrated in FIG. 1 to FIG. 3 and FIG. 6, the flow guide hole 12 is located at the buffer recess 11 and is close to the connection piece recess 21 at a right end. Certainly, in some embodiments not illustrated in the drawings, the flow guide hole 12 may be located at the buffer recess 11 and close to the connection piece recess 21 at a left end, or the flow guide hole 12 may be located at a center position of the buffer recess 11.

In some embodiments of the present disclosure, as illustrated in FIG. 1 and FIG. 2, FIG. 9 and FIG. 10, the battery further includes a connection piece 30 and a pole. The pole passes through the pole through hole 4. The connection piece 30 is located at a side of a second side surface 2 of the plastic component 10 and includes a pole connection segment 301 and a tab connection segment 302. The pole connection segment 301 is directly connected to the tab connection segment 302, or the pole connection segment 301 is indirectly connected to the tab connection segment 302 through a middle connection segment. The pole connection segment 301 is located at a connection piece recess 21 and fixedly connected to the pole. The tab connection segment 302 extends away from the plastic component 10, and an angle between the tab connection segment 302 and the pole connection segment 301 is greater than 70° and smaller than 110°. The tab connection segment 302 is adapted to be connected to other parts of the battery (for example, the tab 401 of the bare cell 40 mentioned below), and the tab connection segment 302 and the pole connection segment 301 are located at different planes, which facilitates an arrangement of the tab connection segment 302 at a position convenient for a connection operation, and decreases a lateral size of the battery (i.e., a dimension of the battery in a F1-F2 direction). Exemplarily, the angle between the tab connection segment 302 and the pole connection segment 301 is 90°, i.e., the tab connection segment 302 is perpendicular to the pole connection segment 301.

In some embodiments of the present disclosure, as illustrated in FIG. 1 and FIG. 2, FIG. 9 and FIG. 10, the battery further includes at least one bare cell 40 provided at a side of the pole connection segment 301 facing away from the plastic component 10. A longitudinal extending direction of the bare cell 40 is consistent with a length direction of the body. A longitudinal end of the bare cell 40 is a tab 401, and the tab 401 is connected to the tab connection segment 302. The length direction of the body is the F1-F2 direction illustrated in FIG. 10, and the longitudinal extending direction of the bare cell 40 is consistent with the length direction of the body, allowing a distance between a great surface of the bare cell 40 and the flow guide hole 12 on the body to be small. In this way, when the electrolyte enters the battery through the flow guide hole 12, the electrolyte may be in contact with the great surface of the bare cell 40 more effectively and quickly, thus facilitating faster immersion of the bare cell 40 and shortening the idle time. In addition, the tab 401 is located at a side surface, which is convenient for a connection between the tab 401 and the tab connection segment 302.

FIG. 11 is a schematic diagram of a relative position of a bare cell 40 and a plastic component 10 in a cross-section perpendicular to the F1-F2 direction in FIG. 10. In some embodiments of the present disclosure, as illustrated in FIG. 1 and FIG. 2, FIG. 10 and FIG. 11, the bare cell 40 has a protrusion 402 protruding towards the plastic component 10. The protrusion 402 includes a proximal portion 4021 close to the plastic component 10 and a distal portion 4022 away from the plastic component 10. A distance between the distal portion 4022 and the plastic component 10 is greater than the distance between the proximal portion 4021 and the plastic component 10. As illustrated in FIG. 11, the distance between the proximal portion 4021 and the plastic component 10 is H1, the distance between the distal portion 4022 and the plastic component 10 is H2, and H2>H1. The proximal portion 4021 is the nearest position of the bare cell 40 from the plastic component 10, which is the highest point of the bare cell 40. A predetermined space is defined between the protrusion 402 and the plastic component 10, which may reduce obstruction of the electrolyte when passing through the space, and facilitate downward flow and diffusion of the electrolyte.

In an example, an outer surface of the protrusion 402 may be configured as a semi-cylindrical surface, such that the proximal portion 4021 is a busbar of the semi-cylindrical surface.

In some embodiments, the projection of the flow guide hole 12 on the protrusion 402 is located at the distal portion 4022. In this way, when the electrolyte enters the interior of the battery through the flow guide hole 12, the electrolyte directly drops on the distal portion 4022 instead of the proximal portion 4021, and the distal portion 4022 can guide the electrolyte faster to a side surface space of the bare cell 40.

Alternatively, in other embodiments, the flow guide hole 12 is offset from the protrusion 402, i.e., the flow guide hole 12 directly faces towards the side surface space of the bare cell 40, and the electrolyte may directly enter the side surface space of the bare cell 40 through the flow guide hole 12.

In some embodiments of the present disclosure, provided is a plurality of flow guide holes 12, i.e., the buffer recess 11 internally has a plurality of flow guide holes 12 penetrating the body in a thickness direction of the body, and two sides of the proximal portion have the plurality of flow guide holes 12. The plurality of flow guide holes 12 may disperse the electrolyte, thereby reducing an impact force on the bare cell 40 and improving the liquid injection efficiency of the battery. In addition, a wetting speed of the electrolyte on the bare cell 40 is enhanced, and the idle time is reduced.

In an example, two flow guide holes 12 are provided and disposed on the distal portions 4022 at two sides of the proximal portion 4021, respectively. Alternatively, in another example, the two flow guide holes 12 may be provided and disposed at two sides of the bare cell 40, respectively.

In other embodiments of the present disclosure, one flow guide hole 12 is provided.

In some embodiments of the present disclosure, there is a plurality of bare cells 40, i.e., the battery includes a plurality of bare cells 40, and a flow guide hole 12 is located at a center line between two adjacent bare cells 40. In this way, a space below the flow guide hole 12 is great, and the obstruction to the electrolyte may be decreased.

In descriptions of this specification, descriptions in the reference terms “an embodiment”, “some embodiments”, “example”, “specific example”, “some examples” or the like mean that the specific features, structures, materials or characteristics described in combination with the embodiments or the examples are included in at least one embodiment or example of the present disclosure. In the present specification, the schematic representation of the above terms does not necessarily mean the same embodiment or example. Moreover, the described specific features, structures, materials or characteristics may be combined in any one or more embodiments or examples in a suitable mode. In addition, various embodiments or examples described in the specification, as well as features of various embodiments or examples, may be combined by those skilled in the art.

Although the embodiments of the present disclosure have been shown and described above, it can be understood that the above-mentioned embodiments are exemplary and should not be construed as limiting the present disclosure. Those of ordinary skill in the art can make changes, modifications, substitutions and modifications to the above-mentioned embodiments within the scope of the present disclosure.

What is claimed is:

1. A plastic component, comprising a body having a first side surface and a second side surface facing away from the first side surface, the first side surface having a buffer recess recessed towards the second side surface, the buffer recess having at least one flow guide hole penetrating the body in a thickness direction of the body, the second side surface having at least one connection piece recess recessed towards the first side surface, a connection piece being at least partially installed and positioned in the connection piece recess, and each of the at least one connection piece recess having a pole through hole penetrating the body in the thickness direction of the body.

2. The plastic component according to claim 1, wherein a projection region of the connection piece recess on the body and a projection region of the buffer recess on the body are offset from each other.

3. The plastic component according to claim 2, wherein an offset between the projection region of the connection piece recess on the body and the projection region of the buffer recess on the body is greater than 0.7 mm and smaller than 1 mm.

4. The plastic component according to claim 1, wherein the second side surface has two connection piece recesses located at two ends of the buffer recess, respectively.

5. The plastic component according to claim 1, wherein:
the first side surface is connected to the second side surface through an outer peripheral surface; and
the second side surface has a thinned recess having an outer peripheral recess wall and a recess bottom wall, the outer peripheral recess wall being apart from the outer peripheral surface, and the connection piece recess being formed at the recess bottom wall.

6. The plastic component according to claim 5, wherein a distance between the outer peripheral recess wall and the outer peripheral surface is smaller than or equal to 10 mm.

7. The plastic component according to claim 5, wherein the connection piece recess is provided with a positioning protruding post protruding away from the first side surface, the positioning protruding post having an end surface flush with the recess bottom wall of the thinned recess.

8. The plastic component according to claim 1, wherein the body is of a flat plate-like structure, and has a length greater than or equal to 300 mm, a width greater than or equal to 107 mm, and a thickness greater than or equal to 4 mm,
wherein the thickness of the body is smaller than or equal to 30 mm.

9. The plastic component according to claim 1, wherein the buffer recess (11) has a length greater than or equal to 285 mm, a width greater than or equal to 100 mm, and a depth greater than or equal to 2.5 mm.

10. The plastic component according to claim 1, wherein:
a dimension of the connection piece recess in a length direction of the body is greater than or equal to 50 mm;
a dimension of the connection piece recess in a width direction of the body is greater than or equal to 86 mm; and
a depth of the connection piece recess is greater than or equal to 2.5 mm.

11. The plastic component according to claim 1, wherein the connection piece recess has a rounded corner arranged at a side of the connection piece recess close to the buffer recess, a fillet radius of the rounded corner being greater than 5 mm and smaller than 20 mm.

12. The plastic component according to claim 1, wherein the pole through hole is located at a center of the body in a width direction of the body.

13. The plastic component according to claim 1, wherein the connection piece recess has a first side wall close to the buffer recess and a second side wall away from the buffer recess, a distance between the pole through hole and the second side wall being greater than a distance between the pole through hole and the first side wall.

14. A battery, comprising the plastic component according to claim 1.

15. The battery according to claim 14, further comprising a cover plate located at a side of the first side surface of the plastic component and having a liquid injection hole, a projection of the liquid injection hole on the first side surface being located at the buffer recess, and the flow guide hole being offset from the liquid injection hole.

16. The battery according to claim 14, further comprising the connection piece and a pole, the pole passing through the pole through hole, the connection piece being located at a side of the second side surface of the plastic component and comprising a pole connection segment and a tab connection segment connected to the pole connection segment, the pole connection segment being located at the connection piece recess and fixedly connected to the pole, the tab connection segment extending away from the plastic component, and an angle between the tab connection segment and the pole connection segment being greater than 70° and smaller than 110°.

17. The battery according to claim 16, further comprising at least one bare cell arranged at a side of the pole connection segment facing away from the plastic component, a longitudinal extending direction of the bare cell being consistent with a length direction of the body, and a longitudinal end of the bare cell being a tab connected to the tab connection segment.

18. The battery of claim 17, wherein the bare cell has a protrusion protruding towards the plastic component, the protrusion comprising a proximal portion close to the plastic component and a distal portion away from the plastic component, a distance between the distal portion and the plastic component being greater than a distance between the proximal portion and the plastic component, and a projection of the flow guide hole on the protrusion being located at the distal portion, or the flow guide hole being offset from the protrusion.

19. The battery according to claim 18, wherein the buffer recess internally has a plurality of flow guide holes penetrating the body in a thickness direction of the body and being formed at two sides of the proximal portion.

20. The battery according to claim 17, wherein the at least one bare cell comprises a plurality of bare cells, a flow guide hole being located at a center line between two adjacent bare cells.
